(19) United States
(12) Patent Application Publication
(10) Pub. No.: US 2017/0262562 A1
(43) Pub. Date: Sep. 14, 2017

(54) ANALOG-FUNCTION DESCRIPTION CREATION APPARATUS, ANALOG-FUNCTION DESCRIPTION CREATION METHOD AND STORAGE MEDIUM

(71) Applicant: Kabushiki Kaisha Toshiba, Tokyo (JP)

(72) Inventor: Hidekana Susa, Ota Tokyo (JP)

(21) Appl. No.: 15/450,884

(22) Filed: Mar. 6, 2017

Related U.S. Application Data
(60) Provisional application No. 62/305,086, filed on Mar. 8, 2016.

(51) Int. Cl. G06F 17/50

(52) U.S. Cl. CPC G06F 17/5022; G06F 17/5045

(57) ABSTRACT

An analog-function description creation apparatus is provided with a design table generator to generate a design table to describe parameter information to be used in an analog-function description model to be designed, variable information specifiable by a user arbitrarily, input port information including a name of at least one input port, output port information including a name of at least one output port, and condition information from the input port to the output port, and an analog-function description creator to create the analog-function description model corresponding to the design table.

### CROSS REFERENCE TO RELATED APPLICATIONS

This application is based upon and claims the benefit of priority from the prior U.S. Provisional Patent Application No. 62/305,086 filed on Mar. 8, 2016, the entire contents of which are incorporated herein by reference.

### FIELD

Embodiments relate to an analog-function description creation apparatus, an analog-function description creation method, and a storage medium.

### BACKGROUND

Large scale analog electric circuitry includes many transistors and hence requires much time for performing simulation at the transistor level. For this reason, there is a well-known method to divide analog electric circuitry into a plurality of circuit blocks and replace each circuit block with an analog-function description model to perform simulation. According to the method, a simulation time can be drastically reduced more than performing simulation at the transistor level.

However, in order to create the analog-function description model, it is required to learn a model description language for analog function description. The model description language is, however, difficult to understand intuitively and a large number of steps are required to create an analog-function description model corresponding to one circuit block. Therefore, it is an actual situation that, even if a simulation time is reduced by using the analog-function description model, it takes much time to create the analog-function description model. As a result, it is difficult to reduce the total time from the start of design to operation verification.

### BRIEF DESCRIPTION OF THE DRAWINGS

FIG. 1 is a block diagram schematically showing an analog-function description creation apparatus 1;

FIG. 2 is a diagram showing an example of a design table;

FIG. 3 is a flowchart showing an example of a detailed operation of an analog-function description creator of FIG. 1;

FIG. 4 is a flowchart showing the operation of step S3 of FIG. 3 in more detail;

FIG. 5 is a circuit diagram of inverting transconductance amplifier circuitry to be designed;

FIG. 6 is an illustration showing an operating voltage range of the amplifier circuitry of FIG. 5;

FIG. 7 is a graph showing input-versus-output voltage characteristics of the amplifier circuitry of FIG. 5;

FIG. 8 is a table showing a correspondence relationship among a power supply voltage VDD, a ground voltage VSS, an input voltage VIN, and a current Iamp, of the amplifier circuitry of FIG. 5;

FIG. 9 is a diagram showing an example of the design table corresponding to the amplifier circuitry of FIG. 5;

FIGS. 10A, 10B and 10C show an example of the analog-function description model corresponding to the design table of FIG. 9;

FIG. 11A is a diagram of equivalent circuitry around an input port;

FIG. 11B is a diagram of equivalent circuitry around an input port;

FIG. 12A is a diagram of equivalent circuitry around an output port;

FIG. 12B is a diagram of equivalent circuitry around an output port; and

FIG. 13 is a diagram of input and output equivalent circuitry of the amplifier circuit of FIG. 5.

### DETAILED DESCRIPTION

An analog-function description creation apparatus according to an embodiment is provided with a design table generator to generate a design table to describe parameter information to be used in an analog-function description model to be designed, variable information specifiable by a user arbitrarily, input port information including a name of at least one input port, output port information including a name of at least one output port, and condition information from the input port to the output port; and

an analog-function description creator to create the analog-function description model corresponding to the design table.

Embodiments will now be explained with reference to the accompanying drawings.

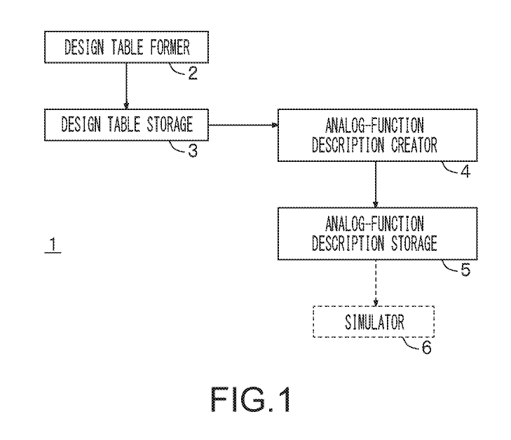

FIG. 1 is a block diagram schematically showing an analog-function description creation apparatus 1. The analog-function description creation apparatus 1 of FIG. 1 is provided with a design table generator 2, a design table storage 3, an analog-function description creator 4, and an analog-function description storage 5.

The design table generator 2 forms a design table that describes parameter information included in an analog-function description model to be designed, variable information specifiable by a user arbitrarily, input port information including a name of at least one input port, output port information including a name of at least one output port, and condition information from the input port to the output port. The design table is data in sheet form that can be formed by a general spreadsheet, for example.

The design table storage 3 stores the design table formed by the design table generator 2. The design table is stored in the design table storage 3, as one file, for example. The design table storage 3 may not always be necessary.

The analog-function description creator 4 creates an analog-function description model corresponding to the design table formed by the design table generator 2.

The analog-function description storage 5 stores the analog-function description model created by the analog-function description creator 4. The analog-function description storage 5 may not always be necessary.

The analog-function description model created by the analog-function description creator 4 is sent to a simulator 6. The simulator 6 performs simulation for operation verification using the analog-function description model. If there are any failures in the analog-function description model as a result of the simulation by the simulator 6, the design table generator 2 corrects the design table, and then again the analog-function description creator 4 recreates the analog-function description model.

At least part of the operation of the analog-function description creation apparatus 1 of FIG. 1 can be performed by, for example, one or more computers. When at least part of the operation of the analog-function description creation apparatus 1 is performed by one or more computers, for example, the design table generator 2 and the analog-function description creator 4 are configured with software. Since input devices such as a keyboard and a mouse are connected to a computer, the design table generator 2 acquires information input by the input devices to generate a design table in the state where software dedicated for design table creation is running.

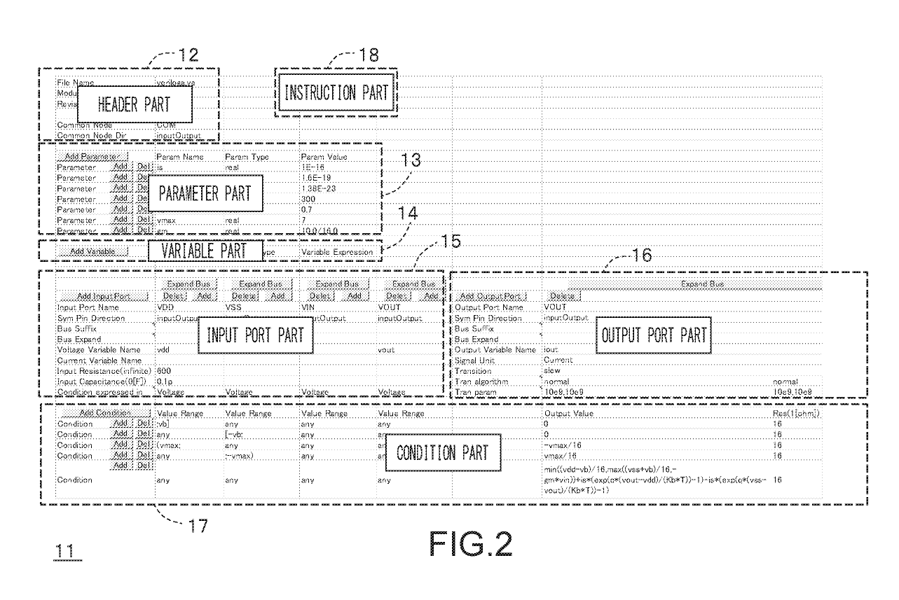

FIG. 2 is a diagram showing an example of the design table 11. The design table 11 of FIG. 2 is, for example, displayed on a screen of a display apparatus (not shown) connected to a computer. A user who forms the design table 11, for example, starts up a spreadsheet on the computer to display a table having no design information described on the screen, which is the base of the design table 11 of FIG. 2, and enters necessary information using input devices to generate the design table 11 of FIG. 2. Or the user may retrieve a design table 11 to be the base from a storage device (not shown) and correct the retrieved design table 11 manually or automatically as required to generate a final design table 11.

At least part of the design table generator 2, design table storage 3, analog-function description creator 4, and analog-function description storage 5 in the analog-function description creation apparatus 1 of FIG. 1 may be configured with hardware circuitry.

The design table 11 of FIG. 2 has a header part 12, a parameter part (first description part) 13, a variable part (second description part) 14, an input port part (third description part) 15, an output port part (fourth description part) 16, a condition part (fifth description part) 17, and an instruction part 18.

In the header part 12, information that identifies at least an analog-function description model is described. As an example, a file name of the analog-function description model, a module name of a circuit block corresponding to the analog function-description model, a name of a ground node, etc. are described.

In the parameter part 13, parameter information used in the analog-function description model is described. The parameter information includes constants having unchangeable values and parameters for which values are given from the outside of the analog-function description creation apparatus 1. The parameters for which values are given from the outside of the analog-function description creation apparatus 1 may change their values depending on conditions.

In the variable part 14, variable information is described. The variable information includes at least either one of a variable having a variable value and an assignment expression for the variable. When only the variable is declared, a variable declaration is created in analog function description. When the assignment expression for the variable is stated, the variable declaration is created in the analog function description and an assignment declaration for the variable is created, following to input-port equivalent circuitry. Depending on the object to be designed, the variable part 14 may not be present.

In the input port part 15, input port information is described. The input port information includes a name of at least one input port, input impedance of the corresponding input port, input physical quantity that includes at least either one of a voltage of and a current of the corresponding input port, etc. The input impedance is at least either one of input capacitance Cin and input resistance Rin.

In the output port part 16, output port information is described. The output port information includes a name of at least one output port, output impedance of the corresponding output port, output physical quantity that includes at least either one of a voltage of and a current of the corresponding output port, etc. The output impedance is at least either one of output capacitance Gout and output resistance Rout.

In the condition part 17, condition information from an input port to an output port is described. The condition information includes at least either one of function information and conditional branch information. The function information is information on a function for calculating at least either one of a voltage and a current each output from the output port using at least either one of a voltage and a current each input to the input port. The conditional branch information is information on conditional branch between at least either one of a voltage and a current each input to the input port and at least either one of a voltage and a current each output from the output port.

The instruction part 18 instructs the analog-function description creator 4 to create an analog-function description model with completion of description in the header part 12, the parameter part 13, the variable part 14, the input port part 15, the output port part 16, and the condition part 17, in the design table 11. The instruction part 18 is, for example, an input button operable by mouse click or human finger touch. A user operates the input button to create an analog-function description model in accordance with the design table 11.

FIG. 2 is one example of the design table 11. A specific configuration and the arrangements of the design table 11 are not limited to those shown in FIG. 2.

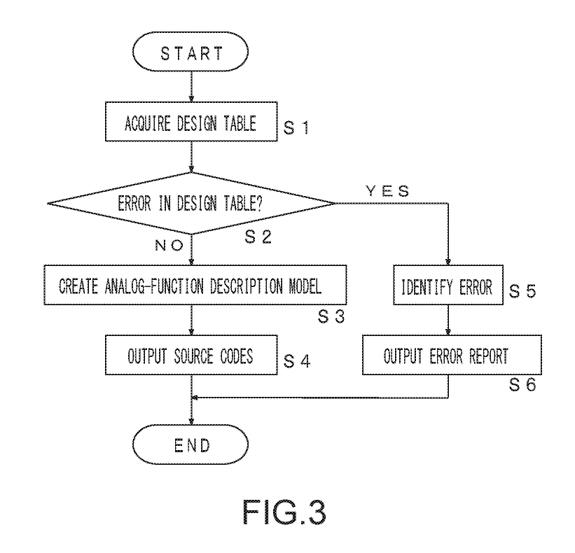

FIG. 3 is a flowchart showing an example of a detailed operation of the analog-function description creator 4 of FIG. 1. Firstly, the analog-function description creator 4 acquires a design table 11 formed by the design table generator 2 (step S1). In step S1, the design table 11 may be directly acquired from the design table generator 2 or a design table 11 stored in the design table storage 3 may be retrieved.

Subsequently, it is checked whether the acquired design table 11 has an error (step S2). In step S2, it is determined that there is an error if the description in the design table 11 does not conform with a predetermined rule, if there is a logical contradiction in the description of the design table 11, etc. In step S2, if it is determined that there is no error, an analog-function description model corresponding to the design table 11 is created (step S3) and source codes of the created analog-function description model are output (step S4). The output of step S4 is, for example, stored in the analog-function description storage 5.

On the other hand, if it is determined in step S2 that there is an error, the error included in the design table 11 is identified (step S5), and an error report is formed and output (step S6). The output error report is, for example, displayed on a screen of a computer or printed out by a printer (not shown). The user checks the error report to correct the design table 11 using the design table generator 2.

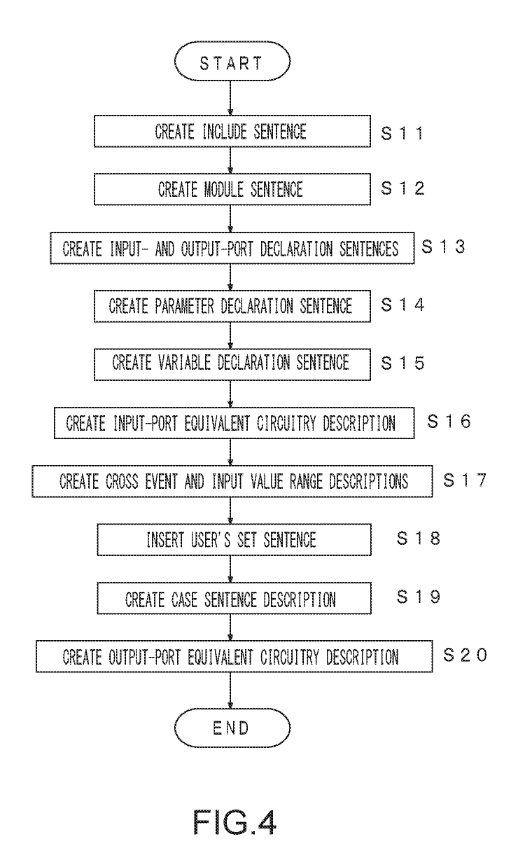

FIG. 4 is a flowchart showing the operation of step S3 of FIG. 3 in more detail. For the analog-function description model, for example, a model for analog circuitry described in a language called Verilog-A, an industry standard language, is applicable. This type of analog-function description model includes a plurality of sentences and descriptions described according to a standardized rule.

In the example of FIG. 4, based on the design table 11 and according to the rule of Verilog-A, creation of an include sentence (step S11), creation of a module sentence (step S12), creation of input- and output-port declaration sentences (step S13), creation of a parameter declaration sentence (step S14), and creation of a variable declaration sentence (step S15) are performed in order.

Subsequently, based on input port information of the design table 11, description of input-port equivalent circuitry is created (step S16). Subsequently, a description of a cross event for specifying a time point setting at a delimiter of a value and a description of specifying an input value range are created (step S17).

Subsequently, a user's set sentence is inserted (step S18) and a description of a case sentence for expressing conditional branch is created (step S19). Subsequently, a description of output-port equivalent circuitry is created (step S20).

The order of performing steps S11 to S20 of FIG. 4 is not limited to that shown in FIG. 4 and the steps may be replaced one another arbitrarily. The analog-function description model to be created may include descriptions other than those in steps S11 to S20 of FIG. 4 or exclude part of steps S11 to S20.

Subsequently, an example of operation to create an analog-function description model using the analog-function description creation apparatus 1 according to the present embodiment will be explained more specifically.

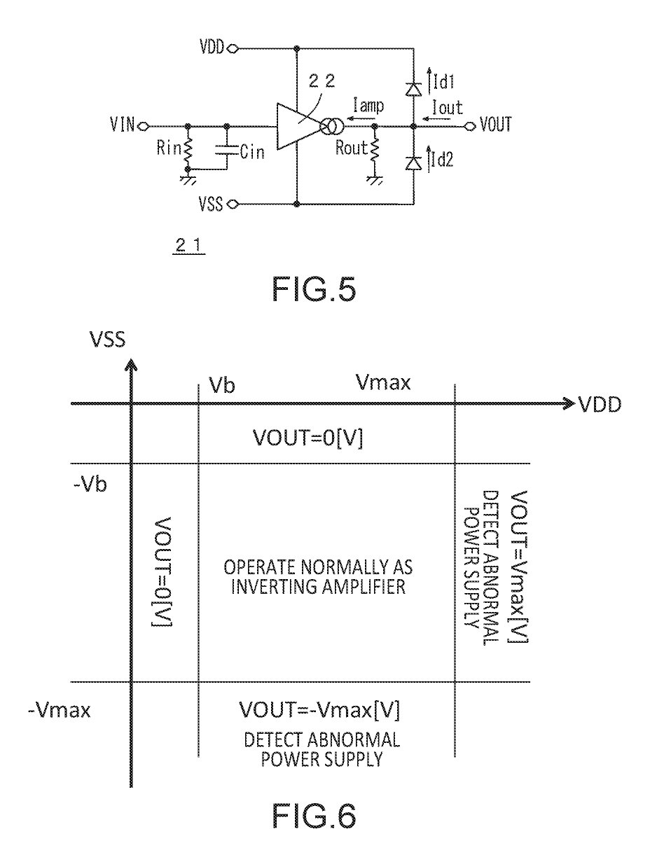

FIG. 5 is a circuit diagram of inverting transconductance amplifier circuitry 21 to be designed. The amplifier circuitry 21 of FIG. 5 is supplied with a positive power-supply voltage VDD and a negative power-supply voltage VSS. The amplifier circuitry 21 of FIG. 5 has a transconductance amplifier 22. Input and output terminals of the amplifier 22 are connected to an input port VIN and an output port VOUT, respectively. To the output port VOUT, protection diodes D1 and D2 are connected to restrict a surge voltage. An anode and a cathode of the protection diode D1 are connected to the output port VOUT and the positive power-supply voltage node VDD, respectively. An anode and a cathode of the protection diode D2 are connected to the negative power-supply voltage VSS and the output port VOUT, respectively.

In FIG. 5, input impedance of the amplifier 22 is represented by input resistance Rin and input capacitance Cin, and output impedance of the amplifier 22 is represented by output resistance Rout. The input impedance has input resistance Rin of 600Ω and input capacitance Cin of 0. 1 [pF]. The output impedance has output resistance Rout of 16Ω. The resistance Rin and Rout, and the input capacitance Cin of the input and output impedance are equivalent circuitry, so that the resistance Rin and Rout, and the input capacitance Cin are not actually provided apart from the amplifier circuitry 21.

The amplifier circuitry 21 of FIG. 5 is circuitry to output a current proportional to an input voltage, having a constant of proportionality Gm=10/16 [S].

FIG. 6 is an illustration showing an operating voltage range of the amplifier circuitry 21 of FIG. 5. As shown in FIG. 6, the amplifier circuitry 21 of FIG. 5 operates normally when the positive power-supply voltage VDD is within a voltage range of Vb<VDD≦Vmax and the negative power-supply voltage VSS is within a voltage range of −Vmax≦VSS<−Vb. Within a voltage range of VDD≦Vb, output voltage VOUT=0[V], whereas within a voltage range of VDD>Vmax, output voltage VOUT=Vmax[V]. Moreover, within a voltage range of VSS≧−Vb, output voltage VOUT=0[V], whereas within a voltage range of VSS<−Vmax, output voltage VOUT=−Vmax[V]. Vmax is a power supply voltage at which the amplifier circuitry 21 is expected to be broken down.

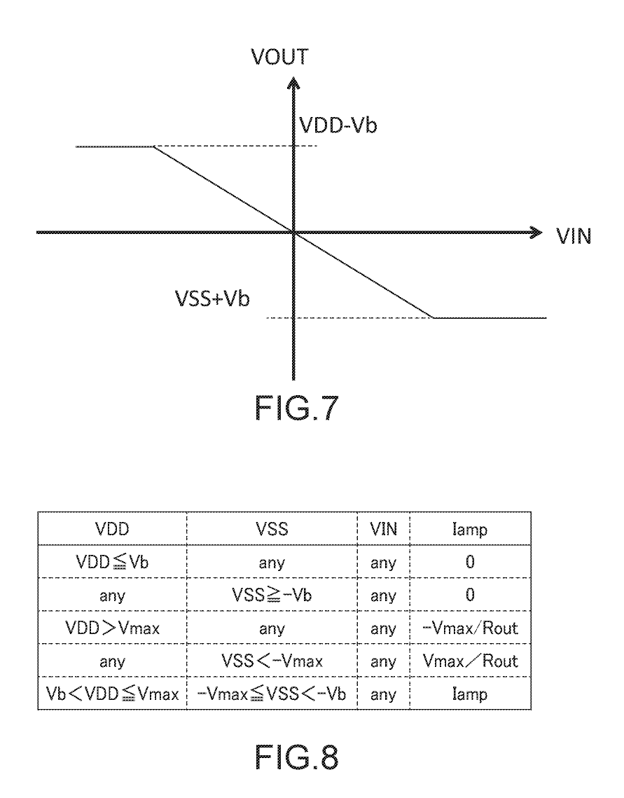

FIG. 7 is a graph showing input-versus-output voltage characteristics of the amplifier circuitry 21 of FIG. 5, with an voltage VIN on the abscissa and an output voltage VOUT on the ordinate. While the amplifier circuitry 21 of FIG. 5 is normally operating, the output voltage VOUT is restricted to be equal to or lower than VDD−Vb in the positive side, whereas to be equal to or higher than VSS+Vb in the negative side. The reason why the output voltage of the amplifier circuitry 21 is restricted as described above is that the amplifier circuitry 21 has a narrow dynamic range.

In FIG. 5, a current Iamp flowing from the output port VOUT of the amplifier circuitry 21 to an output terminal of the amplifier 22 is expressed by the following expression (1).

Iamp=min[(VDD−Vb)/Rout,max{(VSS+Vb)/Rout,Gm×VIN}] (1)

FIG. 8 is a table showing a correspondence relationship among a power supply voltage VDD, a ground voltage VSS, an input voltage VIN, and a current lamp of the amplifier circuitry 21 of FIG. 5, in which “any” means no dependence on a voltage level.

The first line of FIG. 8 indicates current Iamp=0[A] in the case of power supply voltage VDD≦Vb, irrespective of the ground voltage VSS and the input voltage VIN.

The second line of FIG. 8 indicates current Iamp=0[A] in the case of ground voltage VSS≧−Vb, irrespective of the power supply voltage VDD and the input voltage VIN.

The third line of FIG. 8 indicates current Iamp=−Vmax/Rout in the case of power supply voltage VDD>Vmax, irrespective of the power supply voltage voltage VDD and the input voltage VIN.

The fourth line of FIG. 8 indicates current Iamp=Vmax/Rout in the case of ground voltage VSS<−Vmax, irrespective of the power supply voltage VDD and the input voltage VIN.

The fifth line of FIG. 8 indicates current Iamp=−Gm×VIN in the case where the power supply voltage VDD and the ground voltage VSS are other than those in the lines 1 to 4, or Vb<VDD≦Vmax and −Vmax≦VSS<−Vb, irrespective of the input voltage VIN.

Among the five lines in total of FIG. 8, the condition in an upper line is prioritized to the condition in a lower line. For example, in the case of the conditions VDD>Vmax and VSS<−Vmax specified in the third and fourth lines, respectively, the condition in the third line is prioritized to give current Iamp=−Vmax/Rout.

As described above, with the conditions in the five lines in total of FIG. 8, the function of the amplifier circuitry 21 of FIG. 5 can be expressed.

The current IOUT flowing through the output port VOUT of the amplifier circuitry 21 of FIG. 5 is expressed by the following expression (2).

$$\begin{matrix}IOUT = Iamp + Id 1 + Id 2 \\ = \begin{matrix}Iamp + IS \times [ exp \{ q \times ( VOUT - VDD ) / ( n \times Kb \times T ) \} - 1 ] - \\ IS \times [ exp \{ q \times ( VSS - VOUT ) / ( n \times Kb \times T ) \} - 1 ]\end{matrix}\end{matrix} \qquad ( 2 )$$

where IS is a saturation current, with an elementary charge q=1.602×10⁻¹⁹ [C], Boltzmann constant Kb=1.381×10⁻²³ [J/K], and a temperature T=300[K]. Id1 and Id2 are currents flowing through the protection diodes D1 and D2, respectively.

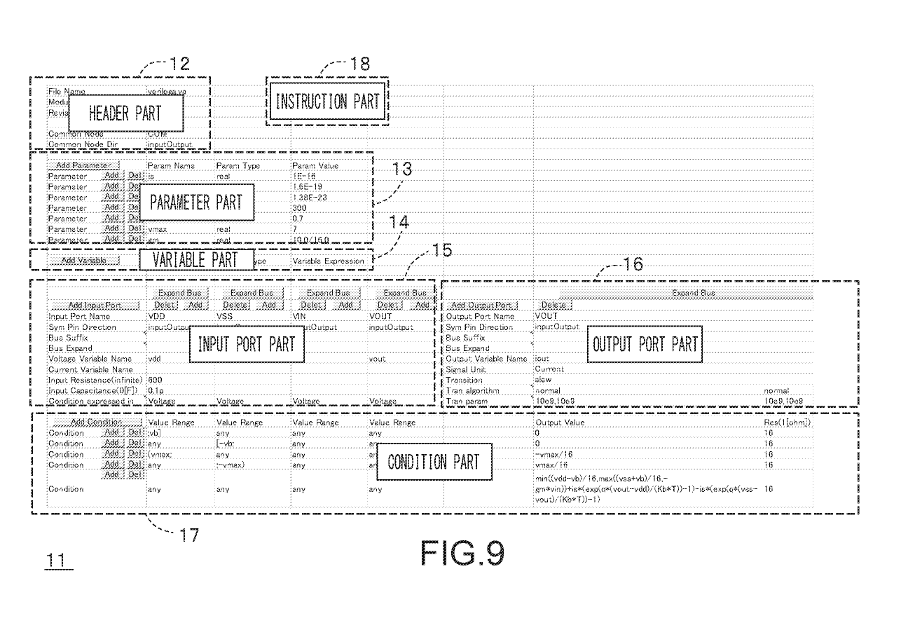

FIG. 9 is a diagram showing an example of the design table 11 corresponding to the amplifier circuitry 21 of FIG. 5. The design table 11 of FIG. 9 is formed by the design table generator 2 of FIG. 1.

In the header part 12 of the design table 11 of FIG. 9, a file name of this design table 11, a name of a circuit block corresponding to this design table 11, a name of a ground node, etc. are described.

In the parameter part 13 of the design table 11 of FIG. 9, seven kinds of parameters and a value of each parameter are described. The seven kinds of parameters are the saturation current IS, elementary charge q, Boltzmann constant Kb, temperature T, voltage Vb, voltage Vmax, and constant of proportionality Gm.

There is no description in the variable part 14 of the design table 11 of FIG. 9, which means that no variable is present in the amplifier circuitry 21 of FIG. 5.

In the input port part 15 of the design table 11 of FIG. 9, information on the power supply voltage VDD, ground voltage VSS, input voltage VIN, and output voltage VOUT, information on the input impedance, etc. are described.

In the output port part 16 of the design table 11 of FIG. 9, information on the output port VOUT is described. This information defines a current IOUT flowing through the output port VOUT.

In the condition part 17 of the design table 11 of FIG. 9, condition information in the five lines in total of FIG. 8 are described, with the output impedance Rout=16Ω.

The condition part 17 of FIG. 9 defines a voltage of and also a current of the output port VOUT. The reason why a voltage and a current are defined for one port is that the voltage and current characteristics are nonlinear. By this definition, it is possible to express a voltage of a port with a current, or a current of a port with a voltage. For a diode, a current Id flowing between an anode and a cathode can be expressed with a voltage V, as shown by the following expression (3).

V=Kb×(273+T)/q×In(Id/Is+1) (3)

Accordingly, by defining both of voltage and current, such as the description of the output port VOUT of the condition part 17 in FIG. 9, the electrical characteristics of the output port VOUT to which the protection diodes D1 are D2 are connected can be correctly expressed.

When conditions of a plurality of lines are described in the condition part 17, as explained in the example of FIG. 8, input port conditions are evaluated in order from the upper-most line to adopt an output port value of a line in which the conditions of all input ports are true, with no evaluation performed for the lines lower than the line.

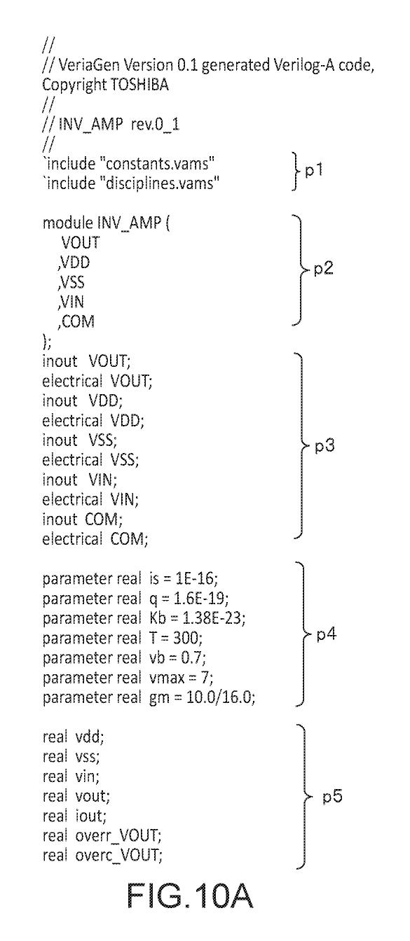

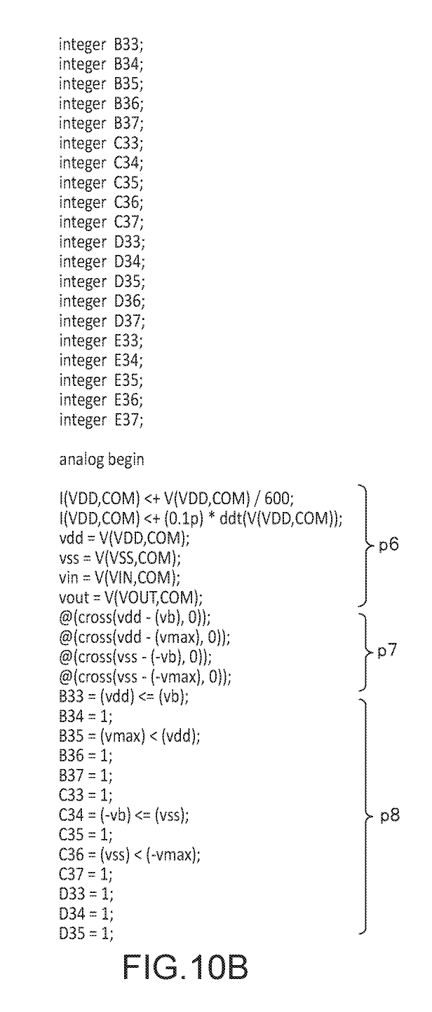

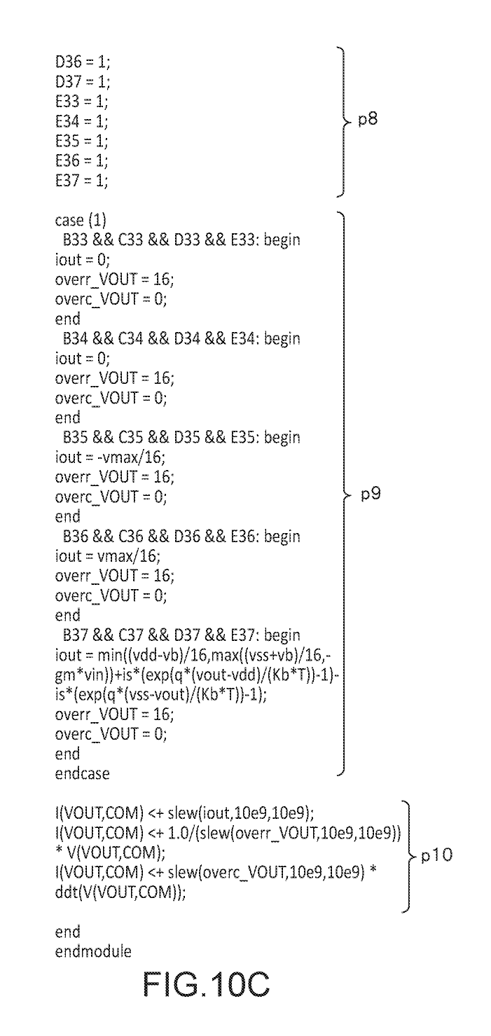

When the design table generator 2 of FIG. 1 completes the creation of the design table 11 of FIG. 9, the analog-function description creator 4 creates an analog-function description model corresponding to the design table 11 of FIG. 9. FIGS. 10A, 10B and 10C show an example of the analog-function description model corresponding to the design table 11 of FIG. 9. The analog-function description creator 4 creates an analog-function description model using the design table 11 of FIG. 9, according to the steps of FIG. 3.

In the analog-function description models of FIGS. 10A, 10B and 10C, a paragraph p1 is an include sentence, a paragraph p2 is a module sentence, a paragraph p3 is an input and output port declaration sentence, a paragraph p4 is a parameter declaration sentence, a paragraph p5 is a variable declaration sentence, a paragraph 6 is a description of input-port equivalent circuitry, a paragraph 7 includes a description of a cross event and a description for specifying an input value range, a paragraph 8 is a user's set sentence, a paragraph 9 is a description of a case sentence, and a paragraph 10 is a description of output-port equivalent circuitry.

Specific description contents of the analog-function description model is not necessary be the same as those shown in FIGS. 10A to 10C. For example, the order of descriptions of paragraphs p1 to p10 may be arbitrarily changed. Moreover, at least part of the descriptions of the paragraphs p1 to p10 may be different from those shown in FIGS. 10A to 10C.

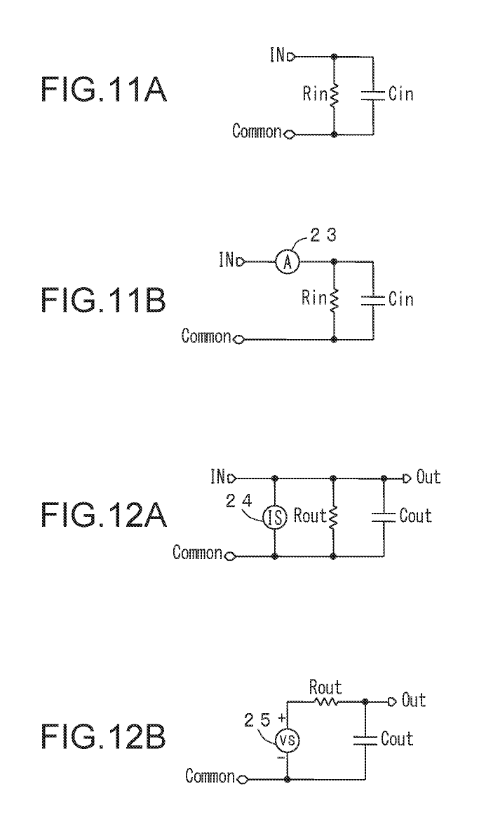

In the example of the design table 11 of FIG. 9, Current Variable Name of the input port information is blank. In this case, the equivalent circuitry around the input port is, as shown in FIG. 11A, circuitry having input resistance Rin and input capacitance Cin connected in parallel between an input port and a ground node. On the other hand, in the case where an arbitrary name is described in Current Variable Name, the equivalent circuitry around the input port is, as shown in FIG. 11B, circuitry having a current sensing circuit element 23 added to the circuitry of FIG. 11A.

In the example of the amplifier circuit 21 of FIG. 5, Signal Unit of the output port information is Current. In this case, the equivalent circuitry around the output port is, as shown in FIG. 12A, circuitry having a current source 24, output resistance Rout, and output capacitance Cout connected in parallel between an output port and a ground node. On the other hand, in the case of Voltage as Signal Unit, the equivalent circuitry around the output port is, as shown in FIG. 12B, circuitry having a voltage source 25 connected to output impedance in series, instead of the current source 24 of FIG. 12A.

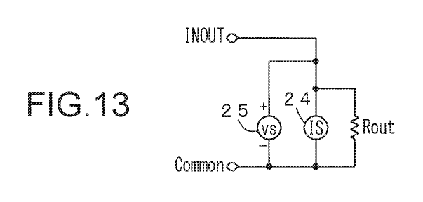

FIG. 13 is a diagram of input and output equivalent circuitry of the amplifier circuit 21 of FIG. 5. Input impedance is omitted in this circuit diagram. As shown in FIG. 13, a current source 24 and a voltage source 25 are connected between an input node INPUT and a ground node Common, and output resistance Rout is connected to the current source 24 in parallel.

As described above, by changing the descriptions of the input port information and output port information in the design table 11 in accordance with the voltage and current characteristics of the input and output ports, the design table 11 having the voltage and current characteristics accurately reflected can be formed. Specifically, by including an output port, having the same name as the name of at least one input port included in input port information, in output port information and, as condition information corresponding to the port of this name, by defining the relationship between an input voltage and an output current or the relationship between an input current and an output voltage, a port having nonlinear voltage and current characteristics can be correctly defined.

As described above, in the present embodiment, since the design table 11, which includes information on analog circuitry to be designed, the information being parameter information, variable information, input port information, output port information, and condition information, is formed, from the design table 11, the analog-function description model can be automatically created. Accordingly, even with no knowledge of a detailed rule of the analog-function description model, the analog-function description model can be created. Therefore, without actually designing analog circuitry, simulation can be performed using the analog-function description model, which shortens the time required for simulation more than simulation using actual analog circuitry. Since the design table 11 can be formed with a general spreadsheet, even a circuit designer with no deep knowledge of the analog-function description model can create the analog-function description model easily and quickly, which reduces the number of design processes up to the creation of the analog-function description model.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

At least part of the analog-function description creation apparatus 1 explained in the embodiment may be configured with hardware or software. When it is configured with software, a program that performs at least part of the analog-function description creation apparatus 1 may be stored in a storage medium such as a flexible disk and CD-ROM, and then installed in a computer to run thereon. The storage medium may not be limited to a detachable one such as a magnetic disk and an optical disk but may be a standalone type such as a hard disk and a memory.

Moreover, a program that achieves the function of at least part of the analog-function description creation apparatus 1 may be distributed via a communication network a (including wireless communication) such as the Internet. The program may also be distributed via an online network such as the Internet or a wireless network, or stored in a storage medium and distributed under the condition that the program is encrypted, modulated or compressed.

1. An analog-function description creation apparatus comprising:
a design table generator to generate a design table to describe parameter information to be used in an analog-function description model to be designed, variable information specifiable by a user arbitrarily, input port information including a name of at least one input port, output port information including a name of at least one output port, and condition information from the input port to the output port; and
an analog-function description creator to create the analog-function description model corresponding to the design table.

2. The analog-function description creation apparatus of claim 1 further comprising an analog-function description storage to store the analog-function description model created by the analog-function description creator.

3. The analog-function description creation apparatus of claim 1, wherein the design table comprises:
a header part to describe identification information of at least the analog-function description model;
a first description part to describe the parameter information;
a second description part to describe the variable information;
a third description part to describe the input port information;
a fourth description part to describe the output port information;
a fifth description part to describe the condition information; and
an instruction part to instruct the analog-function description creator to create the analog-function description model with completion of description by the first to fifth description parts.

4. The analog-function description creation apparatus of claim 1, wherein the parameter information comprises a constant having an unchangeable value and a parameter for which a value is given from outside of the analog-function description creation apparatus.

5. The analog-function description creation apparatus of claim 1, wherein the variable information comprises at least either one of a variable having a variable value and an assignment expression for the variable.

6. The analog-function description creation apparatus of claim 1, wherein the input port information comprises a name of at least one input port, input impedance of a corresponding input port, and input physical quantity including at least either one of a voltage of and a current of the corresponding input port; and
the output port information comprises a name of at least one output port, output impedance of a corresponding output port, and output physical quantity including at least either one of a voltage of and a current of the corresponding output port.

7. The analog-function description creation apparatus of claim 6, wherein the input impedance comprises at least either one of input resistance and input capacitance; and
the output impedance comprises at least either one of output resistance and output capacitance.

8. The analog-function description creation apparatus of claim 1, wherein the condition information comprises at least either one of:
function information for calculating at least either one of a voltage and a current each output from the output port using at least either one of a voltage and a current each input to the input port; and
conditional branch information between at least either one of a voltage and a current each input to the input port and at least either one of a voltage and a current each output from the output port.

9. The analog-function description creation apparatus of claim 1, wherein, when an output port, having a name same as a name of at least one input port included in the input port information, is included in the output port information, the condition information corresponding to a port of the name defines a relationship between an input voltage and an output current or a relationship between an input current and an output voltage.

10. The analog-function description creation apparatus of claim 1, wherein the design table is a sheet form file formed by a spreadsheet.

11. An analog-function description creation method comprising:
generating a design table to describe parameter information to be used in an analog-function description model to be designed, variable information specifiable by a user arbitrarily, input port information including a name of at least one input port, output port information including a name of at least one output port, and condition information from the input port to the output port; and
creating the analog-function description model corresponding to the design table.

12. The analog-function description creation method of claim 11, wherein the analog-function description model created by an analog-function description creator is stored in an analog-function description storage.

13. The analog-function description creation method of claim 11, comprising in the design table:
describing identification information of at least the analog-function description model in a header part;
describing the parameter information in a first description part;
describing the variable information in a second description part;
describing the input port information in a third description part;
describing the output port information in a fourth description part;
describing the condition information in a fifth description part; and
instructing creation of the analog-function description model with completion of description in the first to fifth description parts.

14. The analog-function description creation method of claim 11, wherein the parameter information comprises a constant having an unchangeable value and a parameter for which a value is given from outside of the analog-function description creation method.

15. The analog-function description creation method of claim 11, wherein the variable information comprises at least either one of a variable having a variable value and an assignment expression for the variable.

16. The analog-function description creation method of claim 11, wherein the input port information comprises a name of at least one input port, input impedance of a corresponding input port, and input physical quantity including at least either one of a voltage of and a current of the corresponding input port; and
the output port information comprises a name of at least one output port, output impedance of a corresponding output port, and output physical quantity including at least either one of a voltage of and a current of the corresponding output port.

17. The analog-function description creation method of claim 16, wherein the input impedance comprises at least either one of input resistance and input capacitance; and
the output impedance comprises at least either one of output resistance and output capacitance.

18. The analog-function description creation method of claim 11, wherein the condition information comprises at least either one of:
function information for calculating at least either one of a voltage and a current each output from the output port using at least either one of a voltage and a current each input to the input port; and
conditional branch information between at least either one of a voltage and a current each input to the input port and at least either one of a voltage and a current each output from the output port.

19. The analog-function description creation method of claim 11, wherein, when an output port, having a name same as a name of at least one input port included in the input port information, is included in the output port information, the condition information corresponding to a port of the name defines a relationship between an input voltage and an output current or a relationship between an input current and an output voltage.

20. A non-transitory computer readable storage medium storing a program for creating an analog-function description model, the program comprising:
generating a design table to describe parameter information to be used in an analog-function description model to be designed, variable information specifiable by a user arbitrarily, input port information including a name of at least one input port, output port information including a name of at least one output port, and condition information from the input port to the output port; and
creating the analog-function description model corresponding to the design table.
